(19) United States
(12) Patent Application Publication
(10) Pub. No.: US 2008/0088426 A1
(43) Pub. Date: Apr. 17, 2008

(54) Baby chime

(76) Inventors: Blair Lima, Fort Lauderdale, FL (US); Leila Lima, Fort Lauderdale, FL (US)

Correspondence Address: JAMES RAY & ASSOCIATES, 2640 PITCAIRN ROAD, MONROEVILLE, PA, 15146, US

(21) Appl. No.: 11/974,224

(22) Filed: Oct. 12, 2007

Related U.S. Application Data
(60) Provisional application No. 60/829,358, filed on Oct. 13, 2006.

(51) Int. Cl. B60R 22/48; B60R 22/415; G08B 1/08; G08B 23/00; H04Q 7/00

(52) U.S. Cl. 340/457.1; 180/286; 340/539.11

(57) ABSTRACT

An apparatus for providing an alarm system for alerting parents that a baby is still in a car seat. The apparatus comprises a buckle unit engageable with straps from a car seat when such baby is placed in such car seat, the buckle unit including one of a transceiver and a transmitter. A battery is disposed in the buckle unit for providing power to such buckle unit. There is an antenna unit that is engageable with an automobile's power source, such antenna in electronic communication with the buckle unit. A chime member and a visual signal are disposed one of in and on the antenna unit and are in electronic communication with the buckle unit and the antenna unit. The chime member and visual signal are activated when such vehicle ignition is turned off for alerting users that a baby is still in such car seat. An LED is disposed on the buckle unit for one of indicating that there is power to such buckle unit and that a child is still in such car seat when such automobile's ignition is turned off.

### CROSS REFERENCE TO RELATED APPLICATIONS

This application is closely related to and claims benefit from U.S. Provisional Application Ser. No. 60/829,358 filed Oct. 13, 2006.

### FIELD OF THE INVENTION

The present invention relates, in general, to a baby chime, and, more particularly, the present invention relates to an audio and visual alarm designed to prevent a baby or toddler from being forgotten and left in a car seat.

### BACKGROUND OF THE INVENTION

After the birth of a baby, new parents often find themselves stressed out over every little detail. Not only that, but new parents often find themselves tired as they have to adjust to a new member of the family. While the parents juggle work or other responsibilities along with the care of the child, they often find that they are frequently rushing to complete necessary household chores and daily tasks.

In their hurried state, some may forget to take their child out of the vehicle and leave the child in the car seat. This can lead to a baby being left in a hot car for a prolonged period of time, which can cause dehydration, sickness or even death of the child.

Thus, it would be advantageous if there were a means of alerting a parent that a child was left in the car seat so as to prevent any of the aforementioned serious problems that could occur. This would give peace of mind to any parent.

### SUMMARY OF THE INVENTION

In a first aspect the invention provides for an apparatus for providing an alarm system for alerting parents that a baby is still in a car seat. The apparatus comprises a buckle unit engageable with straps from a car seat when such baby is placed in such car seat, the buckle unit includes one of a transceiver or a transmitter. A power means is disposed in the buckle unit for providing power to such buckle unit. There is an antenna unit that is engageable with an automobile's power source, such antenna is in electronic communication with the buckle unit. A chime member and an LED (visual signal)is disposed in the antenna unit and is in electronic communication with the buckle unit. The chime member and LED (visual signal) are activated when such vehicle ignition is turned off for alerting users that a baby is still in such car seat. A visual indicator (LED) is disposed on the buckle unit for one of indicating that there is power to such buckle unit and that a child is still in such car seat when such automobile's ignition is turned off.

### OBJECTS OF THE INVENTION

It is, therefore, one of the primary objects of the present invention to provide a means for alerting parents that a child was left in a car seat.

Another object of the present invention is to provide a means for alerting parents that is both audio and visual.

Still another object of the present invention is to provide a means for alerting the driver that a child is in the car seat once the ignition is turned off.

Yet another object of the present invention is to provide a means for alerting parents wherein such means is is attached or built in to the car's seat buckle.

Another object of the invention is to provide a means for alerting parents wherein such means is powered by the cigarette lighter or some other automobile power source.

These and various other objects and advantages of this invention will become apparent after a full reading of the following detailed description, particularly, when read in conjunction with the attached drawings as described below and the appended claims.

### BRIEF DESCRIPTION OF THE DRAWINGS

FIG. 1 is a perspective view of a babies car seat showing the buckle unit disposed thereon.

FIG. 2 is a perspective view of an auto's dashboard showing the antenna unit plugged into the automobile's lighter socket used to power the antenna unit.

FIG. 3 is a front view of the buckle unit according to an embodiment of the invention.

FIG. 4 is a cross sectional view of the buckle unit shown in FIG. 3 taken across the line IV-IV.

FIG. 5 is a perspective view of the antenna unit.

FIG. 6 is a cross sectional view of the buckle unit without the seat belt attached showing the contacts touching each other.

FIG. 7 is a cross sectional view of the buckle unit with the seat belt attached showing the contacts being prevented from contacting each other because of the seat belt.

FIG. 8 is a schematic flow chart showing the steps in the operation of the apparatus.

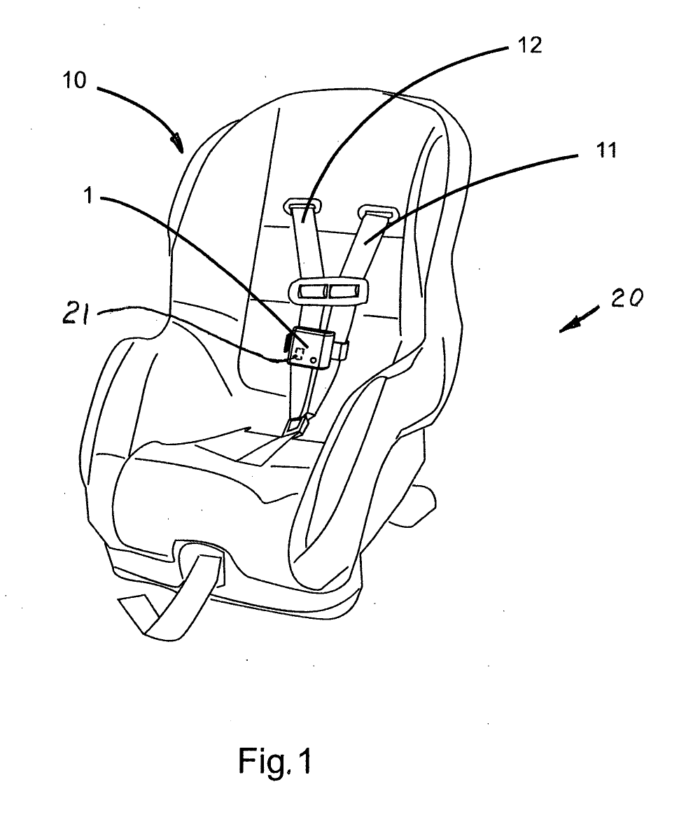

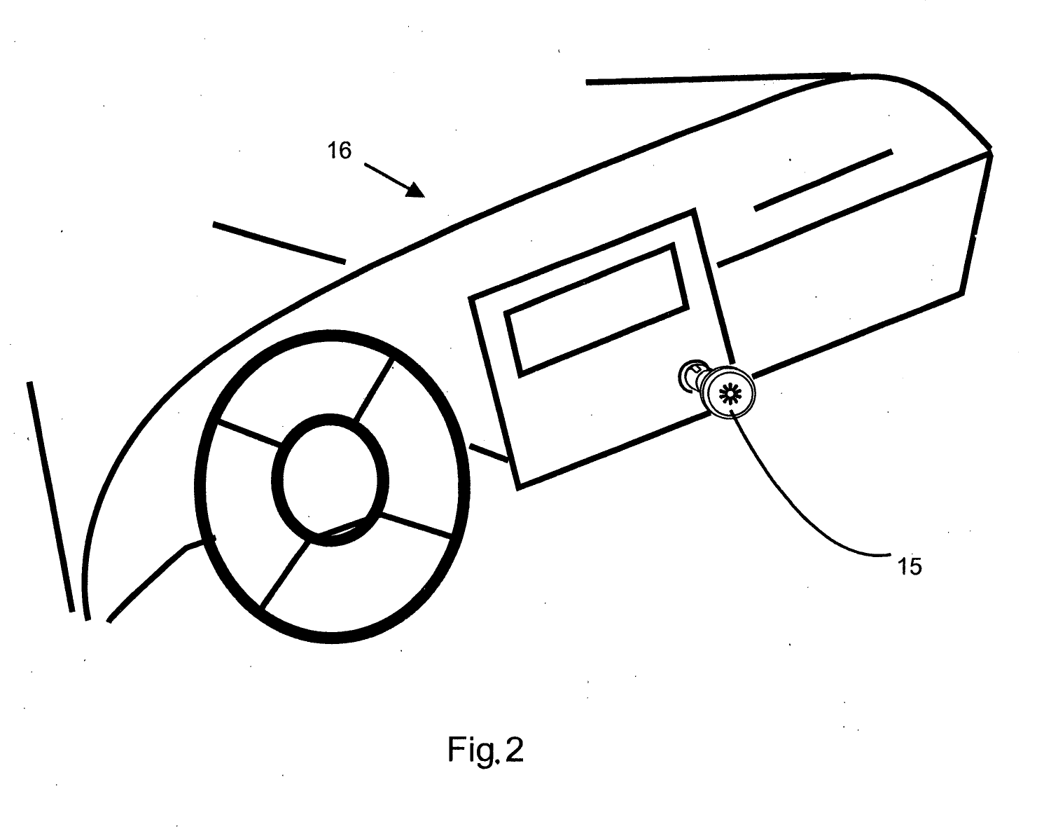

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the invention provides for an apparatus, generally designated 20, for providing an alarm system for alerting parents that a baby is still in a car seat 10. The apparatus 20 comprises a buckle unit 1 that is engageable with straps 11,12 from a car seat 10 when such baby is placed in such car seat 10. Such buckle unit 1 includes one of a transceiver, transmitter or receiver 6. A power means 21 is disposed in the buckle unit 1 for providing power to such buckle unit 1. The power means 21 is a battery 21. Such battery could be a button type battery such as is used in watches or hearing aids. There is an antenna unit 15 that is engageable with a power source of the automobile 16, such antenna unit 15 is in electronic communication with the buckle unit 1. Such power source is usually the cigarette lighter of the automobile 16. A chime member 18 and a visual signal 19 are disposed in the antenna unit 15 and are in electronic communication with the buckle unit 1 and the antenna unit 15. The chime member 18 and the visual signal 19 are activated when such vehicle ignition is turned off for alerting users that a baby is still in such car seat 10. An LED (visual indicator) 13 is disposed on the buckle unit 1 for one of indicating that there is power to such buckle unit 1 and that a child is still in such car seat 10 when such automobile's ignition is turned off.

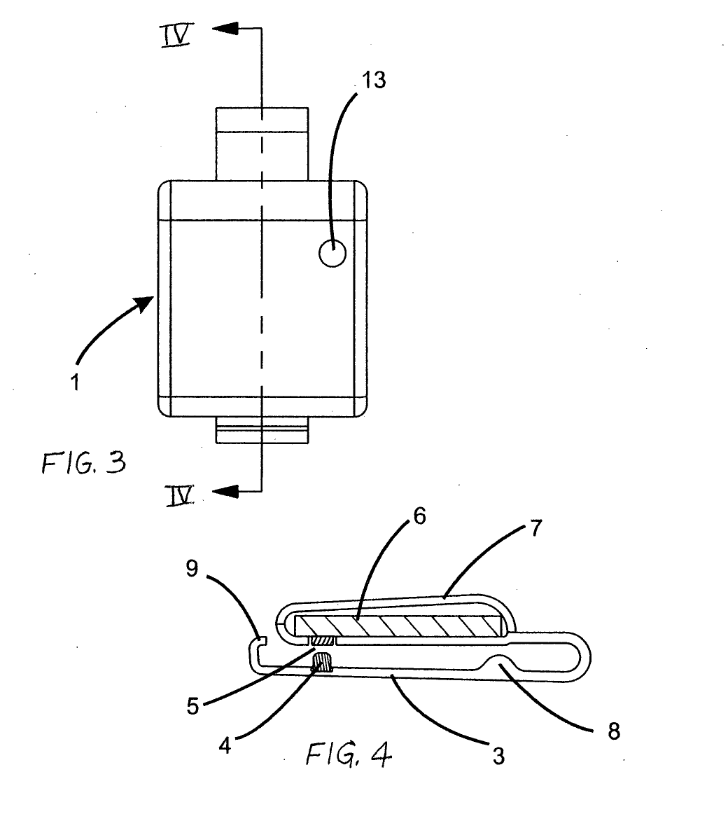

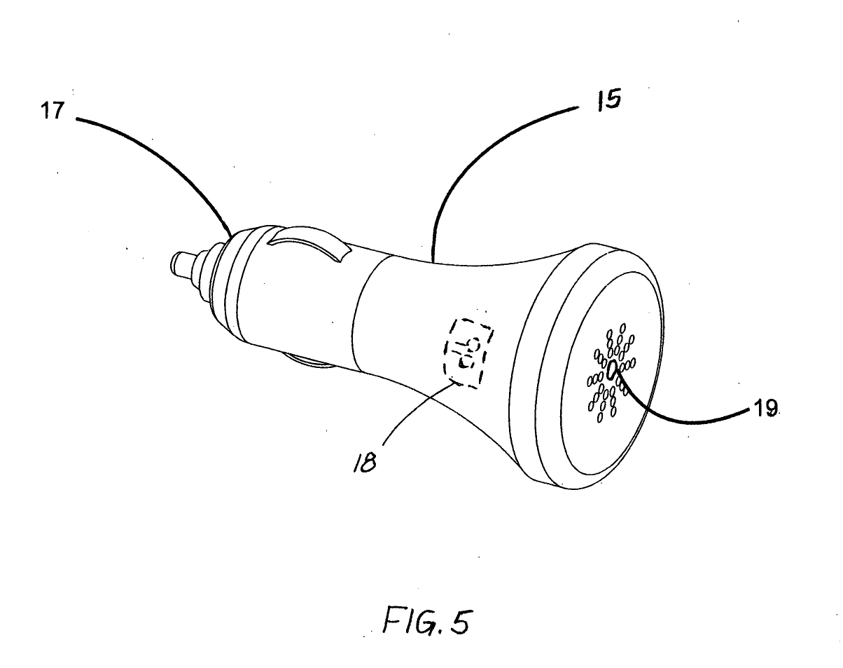

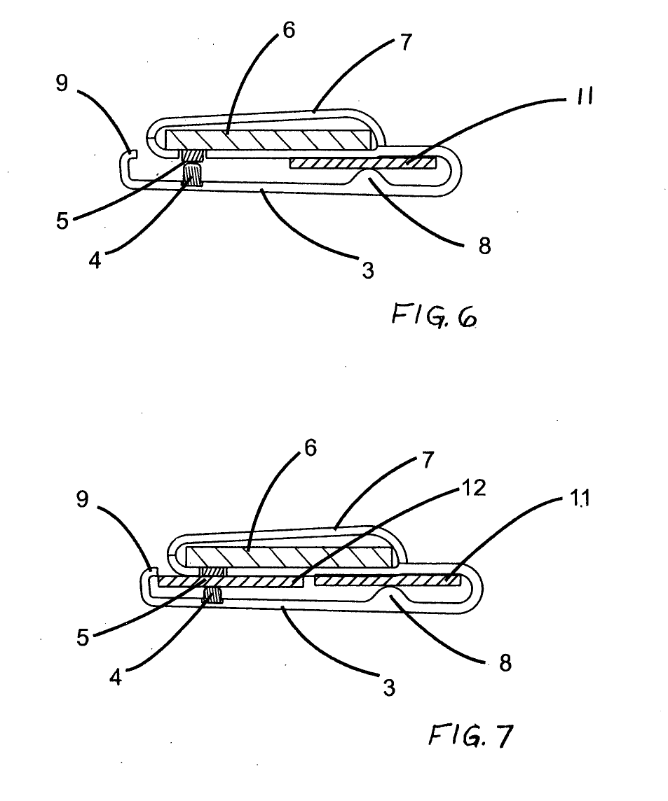

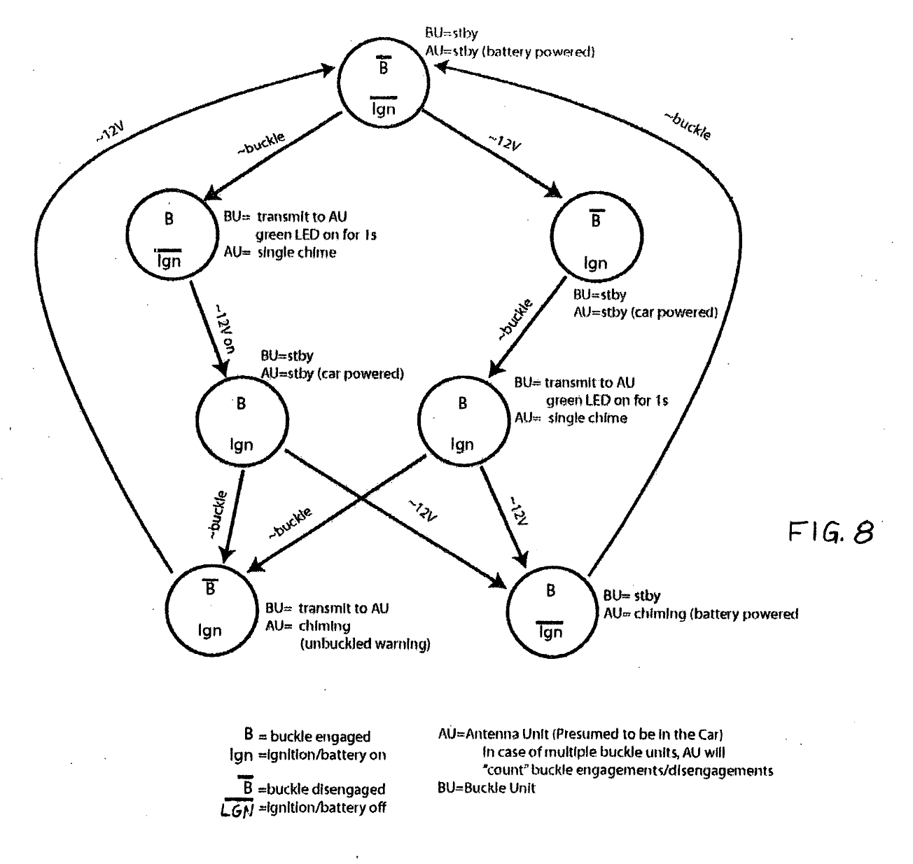

As seen in the drawing FIGS. 3-7 and flow chart 8 whenever the infant is placed in the car seat 10 and the seat belts 11,12 placed over the infant, the parents must slide the seat belt 12 (right seat belt) into the buckle unit 1, placing such seat belt 12 between contacts 4 and 5. Seat belt 11 would already be in place and secured by anti slip 8 feature for the left seat belt 11. When the seat belt 12 is fully-connected and such infant is secured, a green LED 13 (visual indicator)on the exterior of the buckle unit 1 will light up to indicate that the battery is good and there is power to the unit and will also ensure that the buckle unit 1 is connected correctly. The chime member 18 of the antenna unit 15 will chime once to show that it is active. The antenna unit 15 is engaged to an automobile power source, generally this will be the car's cigarette lighter since this is the most convenient.

When the destination is reached and the car's ignition is turned off if the infant remains buckled in the car seat 10 the buckle unit 1 transmits a signal to the chime member 18 and the visual signal 19 of the antenna unit 15 causing the chime member 18 to chime and the visual signal 19 to flash. They will continue to chime and flash until the baby is unbuckled. When the baby is unbuckled, the belt 12 slides out of the buckle unit 1 allowing contacts 4 and 5 to touch thereby closing the circuit and the chime member 18 will be silenced and the visual signal 19 will go off. It should be noted that the chime member 18 in the antenna unit 15 will also chime and the visual signal 19 will be illuminated if the baby is unbuckled and the ignition is on and the car is running.

FIGS. 4,6 and 7 are cross-sectional views of the buckle unit 1 showing the various parts of the unit 1. Seat belt 11,12 slide into the unit 1 by way of belt retainer 9 which is part of spring arm 3 and which provides an opening for the belt to slide into. As mentioned previously left seat belt 11 slides in and is held in place by the anti-slip feature 8 of the buckle unit 1. Right seat belt 12 slides in between lower contact 4 and upper contact 5 and prevents the contacts 4,5 from touching. The upper housing 7 of the buckle unit 1 houses a primary computer board 6 of such transceiver, transmitter or receiver 6.

Thus, the present invention provides an audio/visual alarm system that alerts parents that their baby is still buckled in the car seat, thereby eliminating the possibility of leaving a child unattended in the vehicle. The apparatus is a two part unit that features a buckle unit that is engageable with the baby's car seat and an antenna unit that is plugged into the vehicle's cigarette lighter or other power source. The buckle unit contains a small transceiver, transmitter or receiver that registers with the antenna unit when the buckle is secured in place. The buckle unit also houses a small LED (visual indicator) that comes on once the buckle is locked in place. The LED stays on for a short duration to indicate that the battery is good and also to ensure that the buckle is connected correctly. It should also be noted that there is also an LED (visual signal)on the antenna unit.

The LED on the buckle unit and the antenna unit also will flash once the car power is turned off to let the driver know the child is still in the car seat.

Since the unit draws very little power, the buckle unit can be powered with a small battery. After the antenna is connected to the vehicle's power source, such as a cigarette lighter, and the ignition is turned on, a circuit within the unit will register with the buckle unit using preexisting wireless technology. When the driver reaches their destination and the vehicles ignition is turned off, the antenna unit will give off an audible and visual alarm to alert the driver that the buckle is still connected and the child is still in the car seat. The chime member and visual signal are conveniently housed in the antenna unit to eliminate the chance of the audible alarm waking a sleeping child. The alarm will not cease until the parent has unbuckled the child from the car seat. The buckle unit will reset itself after it has been unbuckled.

While a presently preferred embodiment and alternate embodiments of the present invention has been described in detail above, it should be understood that various other adaptations and/or modifications of the invention can be made by those persons who are particularly skilled in the art without departing from either the spirit of the invention or the scope of the appended claims.

We claim:

1. An apparatus for providing an alarm system for alerting parents that a baby is in a car seat, said apparatus comprising:
(a) a buckle unit engageable with straps from a car seat when such baby is placed in such car seat, said buckle unit includes one of a transceiver and a transmitter;
(b) a power means disposed in said buckle unit for providing power to said buckle unit;
(c) an antenna unit plugged into an automobile's power source, said antenna in electronic communication with said buckle unit;
(d) a chime member and a visual signal disposed in said antenna unit are in electronic communication with said buckle unit and said antenna unit, said chime member and said visual signal are activated when such vehicle ignition is turned off for alerting users that a baby is still in such car seat; and
(e) a visual indicator disposed on an outer surface of said buckle unit for one of indicating that there is power to said buckle unit and that a child is still in such car seat when such automobile's ignition is turned off.

2. The apparatus, according to claim 1, wherein said power means is a battery.

3. The apparatus, according to claim 2, wherein said battery is one of a watch battery and a hearing aid battery.

4. The apparatus, according to claim 1, wherein said visual indicator is illuminated when such car seat buckle is locked in.

5. The apparatus, according to claim 4, wherein said visual indicator will remain on for a predetermined period of time to indicate that said power source is in working order.

6. The apparatus, according to claim 1, wherein said chime member is activated when such automobile engine is turned off and such baby remains buckled.

7. The apparatus, according to claim 6, wherein said chime member will continue to chime while such baby is still buckled in such car seat and such automobile engine is turned off.

8. The apparatus, according to claim 7, wherein said chime member will be silenced when such baby is unbuckled from such car seat.

9. The apparatus, according to claim 1, wherein said chime member will also chime if such baby is unbuckled while such automobile is still running.

10. The apparatus, according to claim 1, wherein said visual signal is illuminated when such automobile engine is turned off and such baby remains buckled in such car seat.

11. The apparatus, according to claim 10, wherein said visual signal will continue to be illuminated while such baby is still buckled in such car seat and such automobile engine is turned off.

12. The apparatus, according to claim 11, wherein said visual signal will go off when such baby is unbuckled from such car seat.

13. The apparatus, according to claim 1, wherein said visual signal will also be illuminated if such baby is unbuckled while such automobile is still running.

14. The apparatus, according to claim 1, wherein said automobile's power source is supplied by such vehicle.
